(19) United States
(12) Patent Application Publication
(10) Pub. No.: US 2004/0156986 A1
(43) Pub. Date: Aug. 12, 2004

(54) Color pigments nanotechnology

(75) Inventor: Tapesh Yadav, Longmont, CO (US)

Correspondence Address: FOLEY AND LARDNER, SUITE 500, 3000 K STREET NW, WASHINGTON, DC, 20007, US

(73) Assignee: NanoProducts Corporation

(21) Appl. No.: 10/724,158

(22) Filed: Dec. 1, 2003

Related U.S. Application Data
(60) Provisional application No. 60/446,234, filed on Feb. 10, 2003.

(51) Int. Cl. B05D 1/12

(52) U.S. Cl. 427/180

(57) ABSTRACT

Nanotechnology relating to color pigments, compositions, formulations, applications, advantages, methods of incorporating pigments into compositions of matter, new color effects are described, and multifunctional pigments, protective pigments, and methods of manufacturing such pigments are disclosed.

### RELATED APPLICATIONS

The present application claims benefit of provisional application No. 60/446,234 filed Feb. 10, 2003, which is hereby incorporated by reference in its entirety.

### BACKGROUND OF THE INVENTION

1. Field of the Invention

The present invention relates to methods of manufacturing color pigment nanoparticles and applications of such powders.

2. Relevant Background

Powders are used in numerous applications. They are the building blocks of electronic, telecommunication, electrical, magnetic, structural, optical, biomedical, chemical, thermal, and consumer goods. Sub-micron and nano-engineered (or nanoscale, nanosize, ultrafine) powders, with a size 10 to 100 times smaller than conventional micron size powders, enable quality improvement and differentiation of product characteristics at scales currently unachievable by commercially available micron-sized powders.

Nanopowders in particular and sub-micron powders in general are a novel family of materials whose distinguishing feature is that their domain size is so small that size confinement effects become a significant determinant of the materials' performance. Such confinement effects can, therefore, lead to a wide range of commercially important properties. Nanopowders, therefore, are an extraordinary opportunity for design, development and commercialization of a wide range of devices and products for various applications. Furthermore, since they represent a whole new family of material precursors where conventional coarse-grain physiochemical mechanisms are not applicable, these materials offer unique combinations of properties that can enable novel and multifunctional components of unmatched performance. Yadav et al. in U.S. Pat. No. 6,344,271 and in co-pending and commonly assigned U.S. patent application Ser. Nos. 09/638,977, 10/004,387, 10/071,027, 10/113,315, and 10/292,263, which along with the references contained therein are all hereby incorporated by reference in their entirety, teach some applications of sub-micron and nanoscale powders.

Color pigments have been used since antiquity. They are the basis of all paints, fabric colors, decoration, cosmetics, etc. and have been used for thousands of years. Pigments are used in a wide range of products, and they express color, emotions, thoughts and distinctiveness. Early pigments were simply created from ground earth or clay. Modem pigments are increasingly sophisticated masterpieces of innovation and chemical engineering.

Inorganic pigments have been sought and developed for ages. For example, iron oxide pigments have been identified and used in cave drawings. During the Renaissance period, oxides of chromium and various multi-metal oxide minerals were increasingly used as pigments. Currently, there are numerous organic pigments (including soluble dyes) and inorganic pigments.

Inorganic pigment colorants are today widely used in many industries, especially in those of paints, plastics, and ceramics. For such applications, thermal stability, chemical stability, dispersibility, color strength, tinting strength, light fastness, transparency and opacifying power, are a few illustrative properties to be taken into consideration in the selection of a suitable pigment.

The state-of-the-art pigments are limited in the performance envelope they offer. For example, while organic pigments and dyes offer pleasing color properties, dispersability, and transparency, they frequently exhibit poor light fastness and thermal/chemical stability. Existing inorganic pigments offer superior light fastness but are often limited in characteristics such as transparency, color strength, and dispersability.

State-of-the-art pigment manufacturing methods are similarly limited in their capabilities. For example, inorganic color pigments are prepared using mineralizers and fluxes at high temperatures. The use of these mineralizers and high temperatures limit the particle characteristics, such as size, that can be achieved. Current methods lead to coarse color pigment powder sizes (above 5 microns, in some cases above 1 micron) in part because of the grain growth that occurs at high temperatures. These coarse powders lead to non-homogeneous dispersions, abrasion damage during the compounding process, and unsatisfactory color performance. To prepare finer powders, grinding or jet milling techniques are employed, but these techniques can cause contamination and loss of color performance.

Similarly, the majority of inorganic pigments employed on an industrial scale generally comprise metals, such as lead, that are increasingly considered environmentally undesirable. A need exists in this art for novel replacement inorganic pigments that are economically viable, suitable for use on an industrial scale, and environmentally benign.

### SUMMARY OF THE INVENTION

Briefly stated, the present invention involves nanoparticulate color pigments, the methods for manufacturing nanoparticulate color pigments, and applications thereof.

In some embodiments, an objective of the present invention is related to nanoparticles of color pigments, which makes it possible to achieve their benefits and motivations for their use.

In some embodiments, an objective of the present invention is related to methods for manufacturing nanoparticles of color pigments.

In some embodiments, an objective of the present invention is to make color pigments that offer color performance distinctively superior to color pigments achievable with mean particle sizes above 700 nanometers.

In some embodiments, an objective is to develop nanostructured color pigments with superior chroma, hue, lightness, masstone, thermal stability, chemical stability, environmental acceptability, tinting strength, shape, surface characteristics, color strength, transparency, lightfastness, permanence, weather fastness, water insolubility, specific gravity, and/or infrared reflectance.

In some embodiments, an objective is to develop nanostructured color pigments that provide simultaneous enhancements in mechanical, electrical, magnetic, electrochemical and/or thermal properties.

In some embodiments, an objective of the invention is to illustrate applications of nanoparticles of color pigments.

In some embodiments, an objective is to develop inorganic pigments with color performance competitive with or superior to organic pigments and dyes.

In some embodiments, an objective is to develop superior colorants and decorating agents for a variety of applications.

In some embodiments, an objective is to develop superior colored products.

In some embodiments, an objective is to develop superior additives for plastics, ceramics, rubber, glass, cosmetics, paper, textiles, paints, inks, toners, adhesives, markers, signs, etc.

In some embodiments, an objective is to describe methods for producing novel color pigment powders in high volume, low-cost, environmentally benign, and reproducible quality.

### BRIEF DESCRIPTION OF THE DRAWINGS

FIG. 1 shows an exemplary overall approach for producing submicron and nanoscale powders in accordance with the present invention.

### DETAILED DESCRIPTION OF THE PREFERRED EMBODIMENTS

This invention is generally directed to inorganic color pigment powders. The scope of the teachings includes high purity powders. Powders discussed herein are of mean crystallite size confined to a domain size less than wavelength of the specific color, in certain embodiments less than half the wavelength of the specific color, and in certain embodiments less than 100 nanometers. Methods for producing and utilizing such powders in high volume, low-cost, and reproducible quality are also outlined.

Definitions

For purposes of clarity the following definitions are provided to aid understanding of description and specific examples provided herein:

“Fine powders” as used herein, refers to powders that simultaneously satisfy the following criteria:

(1) particles with mean size less than 10 microns; and

(2) particles with aspect ratio between 1 and 1,000,000.

For example, in some embodiments, the fine powders are powders with a mean domain size less than 5 microns and with aspect ratios arranging from 1 to 1,000,000.

“Submicron powders” as used herein, refers to fine powders that simultaneously satisfy the following criteria:

(1) particles with mean size less than 1 micron; and

(2) particles with aspect ratio between 1 and 1,000,000.

For example, in some embodiments, the submicron powders are powders that have particles with a mean domain size less than 500 nanometers and with an aspect ratio ranging from 1 to 1,000,000.

The terms “nanopowders,” “nanosize powders,” “nanoparticles,” and “nanoscale powders” are used interchangeably and refer to fine powders that simultaneously satisfy the following criteria:

(1) particles having a mean size less than 250 nanometers; and

(2) particles with an aspect ratio between 1 and 1,000,000.

For example, in some embodiments, the nanopowders are powders that have particles with a mean domain size less than 100 nanometers and with an aspect ratio ranging from 1 to 1,000,000.

“Pure powders,” as the term is used herein, are powders that have composition purity of at least 99.9% by metal basis. For example, in some embodiments the purity is 99.99% or greater.

“Domain size,” as that term is used herein, refers to the minimum dimension of a particular material's microstructural morphology. In the case of powders, the domain size is the grain size. In the case of whiskers and fibers, the domain size is the diameter. In the case of plates and films, the domain size is the thickness.

The terms “powder,” “particle,” and “grain” are used interchangeably and encompass oxides, carbides, nitrides, borides, chalcogenides, halides, metals, intermetallics, ceramics, polymers, alloys, and combinations thereof. These terms include single metal, multi-metal, and complex compositions. These terms further include hollow, dense, porous, semi-porous, coated, uncoated, layered, laminated, simple, complex, dendritic, inorganic, organic, elemental, non-elemental, composite, doped, undoped, spherical, non-spherical, surface functionalized, surface non-functionalized, stoichiometric, and non-stoichiometric forms or substances. Further, the term powder in its generic sense includes one-dimensional materials (fibers, whiskers, rods, tubes, etc.), two-dimensional materials (platelets, films, laminates, planar, etc.), and three-dimensional materials (spheres, cones, ovals, cylindrical, cubes, monoclinic, parallelolipids, dumbbells, hexagonal, truncated dodecahedron, irregular shaped structures, etc.).

The term “aspect ratio” refers to the ratio of the maximum to the minimum dimension of a particle.

“Precursor,” as the term is used herein encompasses any raw substance that can be transformed into a powder of the same or different composition. In certain embodiments, the precursor is a liquid. The term precursor includes, but is not limited to, organometallics, organics, inorganics, solutions, dispersions, melts, sols, gels, emulsions, and mixtures.

“Powder,” as the term used herein encompasses oxides, carbides, nitrides, chalcogenides, metals, alloys, and combinations thereof. The term includes hollow, dense, porous, semi-porous, coated, uncoated, layered, laminated, simple, complex, dendritic, inorganic, organic, elemental, non-elemental, dispersed, composite, doped, undoped, spherical, non-spherical, surface functionalized, surface non-functionalized, stoichiometric, and non-stoichiometric forms or substances.

The terms “coating,” “film,” “laminate,” and “layer” are used interchangeably herein and refer to any deposition comprising submicron or nanoscale powders. These terms include a layer on a substrate, surface, deposition, or a combination. The layer may incorporate substances that are hollow, dense, porous, semi-porous, coated, uncoated, simple, complex, dendritic, inorganic, organic, composite, doped, undoped, patchy, uniform, non-uniform, surface functionalized, surface non-functionalized, thin, thick, pretreated, post-treated, stoichiometric, or non-stoichiometric form or morphology.

“Dispersion,” as the term is used herein encompasses inks, pastes, creams, lotions, Newtonian, non-Newtonian, uniform, non-uniform, transparent, translucent, opaque, white, black, colored, emulsified, with additives, without additives, water-based, polar solvent-based, or non-polar solvent-based mixtures of powders in any fluid or fluid-like state of substance.

“Color,” as the term is used herein encompasses the various hues, lightness, chroma, permanence, stability, fastness, staining power, opaqueness, transparency, strengths and other attributes and characteristics. The definitions, test methods, guidance and standards provided under ASTM, DIN and ISO relating to color and pigments (e.g. ISO #1248, 2809, 3856, 787, 2471, 2469, 8781, 4892, 7724) are hereby incorporated by reference in their entirety. The term “color” as used herein also incorporates and encompasses the definitions, test methods, guidance and standards provided under “DCMA: Classification and Chemical Description of the Mixed Metal Oxide Inorganic Colored Pigments,” Second Edition, Jan. 1982, which is hereby incorporated by reference in its entirety.

This invention is specifically directed to nanoparticulate pigments that exhibit one of the following colors under sunlight, in part of the spectrum of sunlight, or in darkness—red, blue, yellow, green, brown, violet, cyan, buff, pink, magenta, orange, grey, or black. While the teachings herein can be used to develop and apply white pigments, nanoparticles of white pigment are not included in the scope of the current invention. However, it is emphasized that one or more colors may be intentionally engineered into a white pigment to yield an off-white or complex pigment, and these are included in the scope of this patent.

While the description herein focuses on inorganic pigments, the concepts discussed herein apply to organic powders and organic/inorganic nanocomposites as well.

In a generic sense, this invention focuses on nanopigments, i.e. nanoscale powders useful as colors whose domain sizes are confined to a dimension less than the visible wavelength of a specific color wavelength, in certain embodiments less than half the wavelength of the specific color wavelength, in certain embodiments less than 100 nanometers, and in certain embodiments less than 1/10^{th} of the specific color wavelength. Within such domain sizes, surprising effects and multifunctional properties are enabled. To illustrate, but not limit, in contrast with coarse inorganic color pigments with 1 micrometer or greater mean particle size, more transparent colors with high color strengths are enabled with nanotechnology, wherein the transparency of the nanopigment and the coarse pigment is measured at one or more wavelengths between 300 nanometers to 800 nanometers using a spectrophotometer (e.g. UV-Vis spectrophotometer) or laser or any other optical or photonic instrument, wherein the color pigment is in dispersed or dry or batched or blended form. The measurement may be made at any sodium D-line, at 590 nanometers, or any other wavelength between 300 nanometers to 800 nanometers. In certain embodiments, the color nanopigments are at least 10% more transparent than coarse color pigments of substantially same composition with 1 micrometer or greater mean particle size. In certain other embodiments, the color nanopigments are at least 25% more transparent than coarse color pigments of substantially same composition with 1 micrometer or greater mean particle size. In yet other embodiments, the color nanopigments are at least 50% more transparent than coarse color pigments of substantially same composition with 1 micrometer or greater mean particle size. In yet other embodiments, the color nanopigments are at least 90% more transparent than coarse color pigments of substantially same composition with 1 micrometer or greater mean particle size. In yet other embodiments, the color nanopigments are substantially transparent in contrast with coarse color pigments of substantially same composition with 1 micrometer or greater mean particle size. In certain embodiments, the color nanopigments are at least 2% higher in color strength than coarse color pigments of substantially same composition with 1 micrometer or greater mean particle size. In certain other embodiments, the color nanopigments are at least 20% higher in color strength than coarse color pigments of substantially same composition with 1 micrometer or greater mean particle size. In yet other embodiments, the color nanopigments are at least 75% higher in color strength than coarse color pigments of substantially same composition with 1 micrometer or greater mean particle size. In yet other embodiments, the color nanopigments are at least 150% higher in color strength than coarse color pigments of substantially same composition with 1 micrometer or greater mean particle size. In yet other embodiments, the color nanopigments are at least 300% higher in color strength in contrast with coarse color pigments of substantially same composition with 1 micrometer or greater mean particle size.

As an example, the reddish color wavelengths, such as red, red-containing, red-orange, and orange, span from 600 to 700 nanometers. Thus, the teachings herein pertain to reddish color nanoscale powders that are confined to a dimension less than 600 nanometers, in certain embodiments less than 300 nanometers, in certain embodiments less than 100 nanometers, and in certain embodiments less than 60 nanometers.

As another example, the bluish color wavelengths, such as cyan, blue, blue-violet, and violet, span from about 400 (˜380) to 500 nanometers. Thus, the teachings herein pertain to reddish color nanoscale powders that are confined to a dimension less than 400 nanometers, in certain embodiments less than 200 nanometers, in certain embodiments less than 100 nanometers, and in certain embodiments less than 40 nanometers.

Table 1 more specifically lists the focus and scope herein. Table 1 lists the color pigment type and average domain sizes they are confined to within the scope of this invention.

TABLE 1
Color Pigments and desired size limitations in certain
embodiments

| | Confined | Size in certain | Size in certain | Size in certain |
|---|---|---|---|---|
| Color | Domain Size | embodiments | embodiments | embodiments |
| Pigment | (less than) | (less than) | (less than) | (less than) |
| Red | 700 nm | 350 nm | 100 nm | 70 nm |
| Orange | 620 nm | 310 nm | 100 nm | 62 nm |
| Yellow | 580 nm | 290 nm | 100 nm | 58 nm |
| Green | 510 nm | 255 nm | 100 nm | 51 nm |
| Cyan | 460 nm | 230 nm | 100 nm | 46 nm |
| Blue | 420 nm | 210 nm | 100 nm | 42 nm |
| Violet | 400 nm | 200 nm | 100 nm | 40 nm |
| Grey or | 380 nm | 190 nm | 100 nm | 38 nm |
| Black | | | | |

It should be noted that by definition, the term “average” implies a distribution, and the average represents particles from a distribution with particle sizes smaller and larger than the average. The scope includes very small particles (less than 10 nm) where size confinements affect band gap and the electron cloud around the particles yielding quantum and confinement effects.

A key insight herein is that light behaves differently when interacting with domain confined particles, that is, particles with mean sizes close to or less than the wavelength of the color wavelength interacting with the particles. In these circumstances, the entire wavelength of the color photon does not span or pass through the particle, and therefore, conventional effects seen with coarse particles—with sizes much greater than the wavelength of light—no longer satisfactorily apply in light interaction with substances. More complex theories such as the Mie theory are better guidance for effects in these regimes. Effects and properties such as refraction, scattering, reflection, absorption, diffusion, diffraction, etc. in nanostructured materials in general and nanoparticles in particular are unusual and in combination with other teachings herein are commercially useful in certain embodiments.

Nanotechnology offers unusual and surprising effects to achieve color. Some of the non-limiting causes by which specific color or color combinations can result in nanomaterial based pigments in various embodiments are—quantum effects, transitions associated with ligand field effects, transitions between molecular orbitals, scattering, dispersive refraction, diffraction, interference, transitions involving energy bands, charge transfer, dopant effects, allochromism, idiochromism, and Fermi transitions.

### Methods to Manufacture Nanopigment Compositions

While several preferred embodiments for manufacturing color pigments comprising nanoscale powders are disclosed, for the purposes herein, the nanoscale or submicron powders may be produced by any method or may result as a byproduct from any process. Examples of such methods include, but are not limited to, precipitation techniques, combustion techniques, dry or jet milling techniques, chemical or electrically assisted milling techniques, electrochemical techniques, evaporation followed by condensation techniques, arcing techniques, mining followed by separation techniques, and combinations thereof.

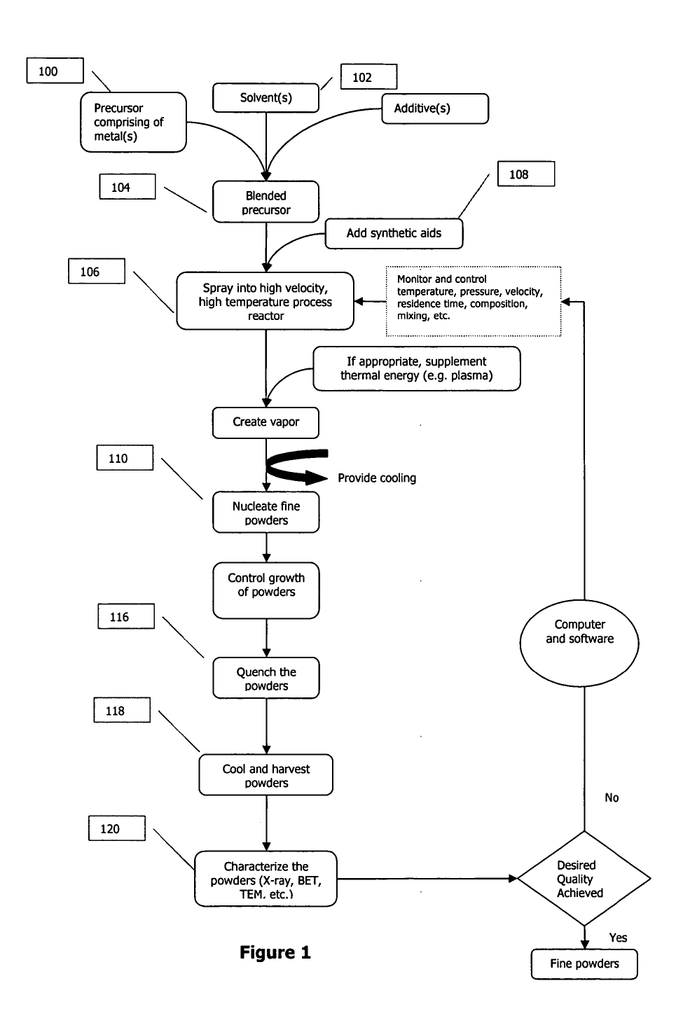

FIG. 1 shows an exemplary overall approach for the production of nanopigment powders. The process shown in FIG. 1 begins with a precursor raw material. Example of precursors include, but are not limited to, coarse oxide powders, metal powders, salts, slurries, solutions, gases, liquids, waste products, organic compounds or inorganic compounds, and combinations thereof. FIG. 1 shows one embodiment of a system for producing nanoscale and submicron powders in accordance with the present invention.

The process shown in FIG. 1 begins at 100 with a metal-containing precursor, such as an emulsion, fluid, particle-containing liquid slurry, or water-soluble salt. The precursor may be a gas, a single-phase liquid, a multi-phase liquid, a melt, a sol, a solution, fluid mixtures, or combinations thereof. The metal-containing precursors, in some embodiments, comprise a stoichiometric or a non-stoichiometric metal composition with at least some part in a fluid phase. Fluid precursors are employed in certain embodiments of this invention. Typically, fluids are easier to convey, evaporate, and thermally process, and the resulting product is more uniform. Solid precursors may also be utilized in certain embodiments.

In certain embodiments, the precursors are environmentally benign, safe, readily available, high-metal loading, lower cost fluid materials. Examples of rare earth metal-containing precursors include, but are not limited to, metal acetates, metal carboxylates, metal carbonates, metal ethanoates, metal alkoxides, metal octoates, metal chelates, metallo-organic compounds, metal halides, metal azides, metal nitrates, metal sulfates, metal hydroxides, metal salts soluble in organics or water, and metal-containing emulsions. Teachings in commonly owned U.S. patent application Ser. No. 10/071,027, which is hereby incorporated by reference in its entirety, may be useful for practicing the present invention.

In another embodiment, multiple metal precursors may be mixed if complex nano-nanoscale and submicron powders are desired. For example, a cerium precursor and praseodymium precursor may be mixed to prepare praseodymium doped cerium oxide powders for reddish nanopigment applications. As another example, a high purity praseodymium precursor, zirconium precursor, and silicon precursor may be mixed in correct proportions to yield a high purity Pr-doped zirconium silicate powder for yellow nanopigment applications. In yet another example, a cobalt precursor and aluminum precursor may be mixed for blue nanopigment applications. A surprising feature of this process may be noted here—this process does not necessarily require the use of fluxes and halides to achieve color. Additionally, such complex two-metal, three-metal, four-metal, five-metal, six-metal, or other multi-metal nanoscale and submicron powders can help create materials with surprising and unusual properties not available through single metal oxides or a simple nanocomposite formed by physical blending powders of different compositions.

Typically, it is desirable to use precursors of a higher purity to produce a nanoscale or submicron powder of a desired purity. For example, if purities greater than x % (by metal weight basis) are desired, one or more precursors that are mixed and used should have purities greater than or equal to x % (by metal weight basis). In certain embodiments, nanoscale color pigments taught herein are prepared from precursors of purities greater than 99% by metal weight, in certain embodiments greater than 99.9% by metal weight, in certain embodiments greater than 99.99% by metal weight, and in certain embodiments greater than 99.999% by metal weight.

With reference to FIG. 1, the metal-containing precursor 100 (containing one or a mixture of metal-containing precursors) is fed, in certain embodiments, into a high temperature process 106 implemented using a high temperature reactor, for example. In one embodiment, a synthetic aid such as a reactive fluid 108 in stoichiometric or non-stoichiometric quantities may be added along with the precursor 100 as it is being fed into the reactor 106. Examples of such reactive fluids include, but are not limited to, oxygen gas, ammonia, nitrogen, methane and air.

While the above embodiments teach methods of preparing nanoscale and submicron powders of oxides, the teachings herein may be readily extended in an analogous manner to other compositions, such as, but not limited to, carbides, nitrides, borides, carbonitrides, and chalcogenides. An illustrative, but non-limiting embodiment of making non-oxides is to select the composition and concentration of the precursor and reactive fluids (e.g. nitrogen containing species if nitrides are desired). While certain embodiments use high temperature processing, a moderate temperature processing or a low/cryogenic temperature processing may also be employed to produce nanoscale and submicron powders.

The precursor 100 may also be pre-processed in a number of other ways before the thermal treatment. For example, the pH is adjusted in certain embodiments to promote precursor stability. Alternatively, selective solution chemistry such as precipitation, is employed in certain embodiments to form a sol or other state of matter. The precursor 100 may be pre-heated or partially or fully combusted before the thermal treatment.

The precursor 100 maybe injected axially, radially, tangentially, or at any other angle into the high temperature region 106. As stated above, the precursor 100 may be pre-mixed or diffusionally mixed with other reactants and thereby atomized. The precursor 100 may be fed into the thermal processing reactor by a laminar, parabolic, turbulent, pulsating, sheared, or cyclonic flow pattern, or by any other flow pattern. In addition, one or more metal-containing precursors 100 may be injected from one or more ports in the reactor 106. The feed spray system may yield a feed pattern that envelops the heat source or, alternatively, the heat sources may envelop the feed, or alternatively, various combinations of this may be employed. In certain embodiments, the feed is atomized and sprayed in a manner that enhances heat transfer efficiency, mass transfer efficiency, momentum transfer efficiency, and reaction efficiency. The reactor shape may be cylindrical, spherical, conical, or any other shape. Methods and equipment such as those taught in U.S. Pat. Nos. 5,788,738, 5,851,507, and 5,984,997, which are all specifically incorporated herein by reference, can be employed in practicing the methods of this invention.

With continued reference to FIG. 1, after the precursor 100 has been fed into reactor 106, it is processed at high temperatures in certain embodiments to form the product powder. As previously noted, the thermal processing may be performed at moderate or low temperatures in other embodiments. In certain embodiments, the thermal treatment is done in a gas environment with the aim to produce a product such as powders that have the desired porosity, density, morphology, dispersion, surface area, and composition. This step produces by-products, such as gases. To reduce costs, these gases may be recycled, mass/heat integrated, or used to prepare the pure gas stream that may be used by the process.

The high temperature processing is conducted at step 106 at temperatures greater than 1500 K, in certain embodiments greater than 2500 K, in certain embodiments greater than 3000 K, and in certain embodiments greater than 4000 K. Such temperatures may be achieved by various methods including, but not limited to, plasma processes, combustion, pyrolysis, electrical arcing in an appropriate reactor, and combinations thereof. The plasma may provide reaction gases or just provide a clean source of heat.

The high temperature process 106 results in a vapor comprising one or more metals depending on the feed composition. The plug flow index (Peclet Number) during the thermal processing and cooling steps, in certain embodiments, is high such that the flow is as close to plug flow as practically achievable. High velocities approaching or exceeding 1 mach are used in certain embodiments during the spraying, thermal processing, and cooling steps.

After the thermal processing, the vapor is cooled at step 110 to nucleate submicron color pigment powders, and in certain embodiments, color pigment nanopowders. In certain embodiments, the cooling temperature at step 110 is high enough to prevent moisture condensation. The nanoparticles form because of the thermokinetic conditions in the process. By engineering the process conditions such as pressure, residence time, supersaturation and nucleation rates, gas velocity, flow rates, species concentrations, diluent addition, degree of mixing, momentum transfer, mass transfer, and heat transfer, the characteristics of the nanoscale and submicron color pigment powders are tailored. It is important to note that the focus of the process should be on producing a powder product that excels in satisfying the end application requirement and customer needs.

After cooling, in certain embodiments, the color pigment nanopowder is quenched to lower temperatures at step 116 to minimize or prevent agglomeration or grain growth. Suitable quenching methods include, but are not limited to, methods taught in U.S. Pat. No. 5,788,738, which is hereby incorporated by reference in its entirety. For this invention, sonic to supersonic quenching is utilized in certain embodiments. In certain embodiments, quenching methods are employed which can prevent deposition of the powders on the conveying walls. These methods may include, but are not limited to, electrostatic means, blanketing with gases, the use of higher flow rates, mechanical means, chemical means, electrochemical means, pressurized gas pulsing, sonication/vibration of the walls, or any such techniques.

In one embodiment, the thermal processing system includes instrumentation and software that can assist in the quality control of the process. Furthermore, in certain embodiments, the high temperature processing zone 106 is operated to produce fine powders 120, in certain embodiments submicron powders, and in certain embodiments nanopowders. The gaseous products from the process may be monitored for composition, temperature and other variables to promote quality at 112. The gaseous products may be recycled to be used in process 108, used as a valuable raw material when nanoscale and submicron powders 120 have been formed, or they may be treated to remove environmental pollutants if any. Following quenching step 116 the nanoscale and submicron powders are cooled further at step 118 and then harvested at step 120 in certain embodiments of this invention.

The product nanoscale and submicron powders 120 may be collected by any method. Suitable collection means include, but are not limited to, bag filtration, electrostatic separation, membrane filtration, cyclones, impact filtration, centrifugation, hydrocyclones, thermophoresis, magnetic separation, and combinations thereof. In certain embodiments, anti-static separation surfaces are employed and used with any collection method.

In certain embodiments, the process described above is operated at sub-ambient pressures (in certain embodiments between 0.7 torr and 700 torr, in certain embodiments between 200 torr and 650 torr), although lower or higher pressures may be employed in certain embodiments. The sub-ambient pressures are achieved using equipment such as vacuum pumps, evacuation assembly, eductors, and others.

The quenching at step 116 may be modified to enable preparation of coatings. In this embodiment, a substrate may be provided (in batch or continuous mode) in the path of the quenching powder containing gas flow. By engineering the substrate temperature and the powder temperature, a coating comprising the submicron powders and nanoscale color pigment powders may be formed.

A coating, film, or component may also be prepared by dispersing the fine nanopowder into a dispersion and then applying various known methods, such as, but not limited to, electrophoretic deposition, magnetophoretic deposition, spin coating, dip coating, spraying, brushing, screen printing, ink-jet printing, toner printing, and sintering. In certain embodiments, the nanopowders are thermally treated (in reducing, oxidizing or inert environment) or reacted before applying a coating to enhance their electrical, optical, photonic, catalytic, thermal, magnetic, structural, electronic, emission, processing, or forming properties.

It should be noted that intermediates or products at any stage may be used directly as feed precursors to produce nanoscale or fine powders by methods, such as, but not limited to, those taught in commonly owned U.S. Pat. Nos. 5,788,738, 5,851,507, and 5,984,997, and co-pending U.S. patent application Ser. Nos. 09/638,977 and 60/310,967, which are all incorporated herein by reference in their entirety. For example, a sol may be blended with a fuel and then utilized as the feed precursor mixture for thermal processing above 2500 K to produce nanoscale simple or complex powders.

In summary, one non-limiting embodiment for manufacturing color pigment powders consistent with teachings herein, comprises (a) preparing a fluid precursor comprising a fluid precursor comprising a metal; (b) feeding the said precursor into a high temperature reactor operating at sub-ambient pressures and temperatures greater than 1500 K, in certain embodiments greater than 2500 K, in certain embodiments greater than 3000 K, and in certain embodiments greater than 4000 K; (c) wherein, in the high temperature reactor, the precursor converts into vapor comprising the metal; (d) the vapor is cooled to nucleate nanopigment powders; (e) the powders are then quenched and cooled at high gas velocities to prevent agglomeration and growth; and (f) the quenched and cooled powders are filtered from the gases.

In another embodiment, a method for manufacturing color pigment powders comprises (a) preparing a fluid precursor comprising two or more metals; (b) feeding the precursor into a high temperature reactor operating at sub-ambient pressures and temperatures greater than 1500 K, in certain embodiments greater than 2500K, in certain embodiments greater than 3000 K, and in certain embodiments greater than 4000 K; (c) wherein, in the high temperature reactor, the precursor converts into vapor comprising the metals; (d) the vapor is cooled to nucleate submicron or nanoscale nanopigment powders at high gas velocities (greater than 0.1 mach); (e) the powders are then cooled and quenched at high gas velocities (greater than 0.1 mach) to prevent agglomeration and growth; and (f) the quenched and cooled powders are filtered from the gases.

In yet another embodiment, a method for manufacturing colored coatings comprises (a) preparing a fluid precursor comprising two or more metals; (b) feeding the precursor into a high temperature reactor operating at temperatures greater than 1500 K, in certain embodiments greater than 2500 K, in certain embodiments greater than 3000 K, and in certain embodiments greater than 4000 K; (c) wherein, in the high temperature reactor, the precursor converts into vapor comprising the metals; (d) the vapor is cooled to nucleate color pigment powders; and (e) the powders is then directed and quenched onto a substrate to form a colored coating comprising the metals on the substrate.

The powders produced by the teachings herein may be modified by post-processing by any method, such as those taught by commonly owned U.S. patent application Ser. No. 10/113,315, which is hereby incorporated by reference in its entirety.

The powders produced by teachings herein may be dispersed on the surface of other powders or bonded into core-shell type nanocomposite powders by any method. For illustration, U.S. patent application Ser. No. 10/004,387, which is hereby incorporated by reference in its entirety, teaches such methods. Other methods may additionally be employed to coat color nanopigments in order to enhance processability, thermal stability, chemical stability, and/or color performance. Non-limiting illustrations of such coatings include, but are not limited to, silica, alumina, ceria, zinc oxide, titanium oxide, and zirconium oxide.

In various applications, in addition to color strength, other color attributes are very important. Some or all of these attributes depend at least partially on particle size. To optimize these attributes, the nanoparticle pigments may be processed after they have been manufactured to achieve optimal particle size. For example, thermal treatment in an appropriate environment, such as oxidizing, inert, or reducing environments, and for appropriate duration can be used to grow the particles or to change the particles' surface, shape, or agglomerate size. The particles may be grown to any desired size, such as 100-500 nm, 500-1000 nm, or 1000-5000 nm. The thermal treatment profile (heating rate, hold duration and cooling rate) may be varied to identify the conditions that yield powders with the best performance and economics.

In certain embodiments of this invention, one determines the average packing number of the color nanopigments by the equation

P=(1/Nₚ)*(D³/dₚ³)

Where, P=average packing number; Nₚ=average number of particles per aggregate; D=average diameter of the aggregate; dₚ=average particle diameter (the terms in the above equation may be indirectly estimated and/or experimentally determined using various techniques such as high resolution transmission electron microscopy).

In certain embodiments, nanopigments are prepared with surface characteristics such that the average packing number as defined above is less than or equal to 1000, in certain embodiments less than 100, in certain embodiments less than 10, and in certain embodiments less than 5.

In one embodiment, a method for preparing color pigment powders comprises (a) preparing nanoscale powders of desired color by any method, such as a method with at least one step operating above 150.0 K and in certain embodiments above 2500 K; (b) thermally treating the prepared nanoscale powder in a controlled environment at temperatures above 200° C., in certain embodiments above 500° C., and in certain embodiments above 800° C., for a controlled duration of time to modify the surface and/or increase the mean particle size of the powders; and (c) collecting the thermally treated colored powders. While it is best to experimentally or with a model establish the best duration at given temperature for thermal treatment of a desired quantity of nanoscale powders, in certain embodiments heat treatment rates greater than 1 gram per minute are used, in certain embodiments heat treatment rates greater than 10 grams per minute are used, in certain embodiments heat treatment rates greater than 100 grams per minute are used, and in certain embodiments heat treatment rates greater than 1000 grams per minute are used.

Similar to inorganic nanopigments, organic nanopigments may be prepared by any methods taught herein. For example, in certain embodiments, controlled precipitation methods are employed to prepare organic pigments. This method involves first preparing a solution comprising the organic pigment in a solvent, evaporating the solvent or lowering the temperature of the solution which leads to the creation of supersaturated solution. The supersaturated solution causes nucleation of nanoparticles which may then be filtered from the solvent.

In certain embodiments, the organic pigment is cryogenically milled or jet milled to convert larger organic pigments into nanopigments.

In certain embodiments, the organic pigments are synthesized in nanoscale reactors, such as nanotubes, nanopores, nano-emulsions and the like.

### Illustrations of Pigment Compositions

The manufacturing methods discussed herein may be used to produce a wide range of color nanoscale powder pigments. In certain embodiments, the color nanopigment compositions may be engineered to (a) comprise two or more metals (or semimetals), and (b) comprise at least one metal or semimetal with atomic number equal to or greater than 21 (in certain embodiments with partially filled d shells or f shells). Illustration of metals to meet the two metal requirement include but not limited to—Na, K, Mg, Ca, Ba, Sr, Be, Hf, Ti, W, Ta, Ni, Zr, V, Co, Cr, Mo, Cd, Mn, Fe, Si, Zn, Cu, Ag, Au, Pb, Hg, Sb, Se, Te, Bi, Nb, Sn, In, B, Al, Ga Sc, Y, La, Ce, Pr, Nd, Pm, Sm, Eu, Gd, Tb, Dy, Ho, Er, Tm, Yb, and Lu. In certain embodiments, oxygen or other non-metals, such as sulfur, nitrogen, carbon, phosphorus, and halogens may be usefully incorporated into the nanopigment composition during synthesis of the nanopigment or through later secondary processing. Dopants with concentrations less than 10% by metal weight basis and/or the ratio of the two or more elements are varied in certain embodiments to adjust the beauty and other color performance of the nanopigment particles. Similarly, stoichiometric or non-stoichiometric metal ratio or oxygen content are adjusted in certain embodiments to optimize the color.

For yellow color, illustrative but non-limiting specific compositions of nanoparticulate pigments include—praseodymium zirconium silicate, zirconium vanadium oxide, lead antimony oxide, lead tin oxide, nickel antimony titanium oxide, nickel niobium titanium oxide, bismuth vanadium oxide, cerium oxide, and tin vanadium oxide.

For blue color, illustrative but non-limiting specific compositions of nanoparticulate pigments include—cobalt aluminum oxide, cobalt silicon oxide, cobalt zinc silicate, cobalt tin oxide, cobalt zinc aluminum oxide, cobalt tin aluminum oxide, boron cobalt magnesium oxide, and zirconium vanadium oxide.

For green color, illustrative but non-limiting specific compositions of nanoparticulate pigments include—chromium iron oxide, nickel oxide, nickel silicate, chromium iron oxide, chromium calcium silicate, chromium cobalt aluminum oxide, cobalt titanium oxide, cobalt chromium oxide, cobalt chromium titanium oxide, and calcium nickel aluminum oxide.

For brown color, illustrative but non-limiting specific compositions of nanoparticulate pigments include—chromium manganese zinc oxide, chromium manganese iron oxide, chromium iron zinc silicate, zinc iron oxide, nickel iron oxide, iron oxide, chromium iron oxide, iron titanium oxide, titanium manganese niobium oxide, and titanium manganese chromium antimony oxide.

For red color, illustrative but non-limiting specific compositions of nanoparticulate pigments include—praseodymium cerium oxide, calcium chromium tin silicon oxide, rare earth aluminum oxide, rare earth silicon oxide, rare earth zirconium oxide, cadmium selenium sulfide, cadmium selenium oxysulfide, and mercury sulfide.

For pink color, illustrative but non-limiting specific compositions of nanoparticulate pigments include—iron zirconium silicon oxide, chromium aluminum oxide, manganese aluminum oxide, praseodymium cerium oxide, and calcium chromium tin silicon oxide.

For black color, illustrative but non-limiting specific compositions of nanoparticulate pigments include—chromium copper oxide, iron cobalt oxide, praseodymium cerium oxide, iron cobalt chromium oxide, manganese iron oxide, and chromium nickel iron oxide.

For gray color, illustrative but non-limiting specific compositions of nanoparticulate pigments include—chromium copper oxide, cobalt nickel oxide, titanium vanadium antimony oxide, tin antimony oxide, iron cobalt chromium oxide, manganese iron oxide, and chromium nickel iron oxide.

Other colors such as purple, violet, primrose, buff, orchid, blue green, orange can similarly be produced by preparing a nanoscale oxide powder comprising two or more metals. In order to determine and optimize the color differences and pigment performance, the International Standards Organization's CIELAB and related standards (such as but not limiting to ISO #7724, 787, 8780, 8780, 8781, 6504, 1812), which are herein incorporated by reference in their entirety, may be utilized.

Instead of oxides, various color nanopigments can also be prepared as acetates, hydrates, carbonates, nitrites, nitrides, oxynitrides, oxycarbides, carbonitrides, cyanides, phosphates, sulfides, phosphates or borides. Nanocomposite colors can also be prepared.

A unique and surprising capability enabled by nanopigments is the ability to mix two or more colors to achieve other colors while maintaining uniformity. Given that the human eye's resolution is at best in the 1 to 10 micron range, nanoparticle colors when mixed can be resolved individually, and therefore, a pleasing uniform mixture may be obtained. Since three primary colors can be mixed to achieve all colors, nanoparticle pigments can enable significant simplification in color mixing technology.

The methods described herein are used in certain embodiments to optimize the powder characteristics (composition, particle size, size distribution, surface, dopants, phase, dispersability, etc.) to achieve the desired color and color performance as measured by the tristimulus method using a three-filter calorimeter, the spectral method using a reflectance spectrophotometer, and/or other techniques. These powder characteristics may be varied by varying the feed materials and process parameters, such as, but not limited to, feed composition, feed ratios, metal to oxygen ratio in the process feeds, residence time, process temperature, process pressure, heat transfer rates, mixing, diluent types, diluent concentrations, recycle rate, quench rates, and velocities. Illustrations of characteristics that may be measured and used to guide the optimization process include:

1. Hue, that is, the spectrum of a color, such as red, orange, yellow, green, blue and violet;

2. Lightness, that is, the value of the color in comparison to pure white;

3. Chroma, that is, the saturation, richness, or intensity of the color in comparison to a colorless gray of the same lightness (also see ISO section 7724);

4. Lightfastness, that is, resistance to unacceptable color change and fading under light exposure (also see ISO sections 787 and 2809);

5. Permanence, that is, resistance to damage from heat, water, humidity, sweat, salt spray, acids, alkalis, and other agents (also see ISO sections 1812 and EN 2812);

6. Specific gravity, which is the ratio of the weight of the pigment to the volume of water it displaces in solution (lighter pigments are typically more desirable since they can remain dispersed longer and require less stirring while being applied) (also see ISO section 787);

7. Tinting strength of a pigment defines the amount of pigment required to impart color to a test amount of clear liquid or white paint; alternatively, relative tinting strength can be interpreted as the ratio of absorption coefficients of equal masses of test and reference pigments (also see ISO sections 8781 and 787);

8. Transparency of a pigment is the reciprocal of the increase in color difference on a black substrate obtained on increasing the film thickness of the pigmented medium (also see ISO section 2469);

9. Opacity or hiding power of a pigment is the thickness of a film of pigment that is required to completely mask a black and white pattern on a painted surface (also see ISO section 2471);

10. Masstone which is the color appearance of the pigment applied on a pure white surface as a layer that does not hide the surface completely.

One of the benefits of the teachings herein is that in several embodiments, nanoparticle pigments are typically simultaneously more transparent, more staining, and stronger in mixtures—the enhancement being at least 10% over color pigment particles of same composition with mean size greater than 1 micron. However, by changing the particle size and composition as discussed above, various combinations of color performance can be achieved with nanopigments.

Nanopigments may also be combined with binders to enhance their adoption and ease in commercial applications. Such dispersions often need wetting, disintegration of agglomerates, and stabilization with solvate layers. Additionally, it is important that the binder selected does not interact with the nanopigment leading to (a) unacceptable color changes, (b) unacceptable oil absorption, or (c) unacceptable smear point, yield point, or viscosity.

### Methods for Incorporating Nanopigments Into Products

The submicron and nanoscale powders taught herein may be incorporated into a composite structure by any method. Some non-limiting exemplary methods are taught in a commonly owned U.S. Pat. No. 6,228,904 which is hereby incorporated by reference in its entirety.

The submicron and nanoscale pigment powders taught herein may be incorporated into plastics by any method. In one embodiment, a method for coloring plastic comprises (a) preparing nanoscale or submicron pigment powders by any method, such as a method that includes a step that operates above 1500 K and in certain embodiments above 2500 K; (b) providing powders of one or more plastics; (c) mixing the nanoscale or submicron pigment powders with the powders of plastics; and (d) co-extruding the mixed powders into a desired shape at temperatures greater than the softening temperature of the powders of plastics but less than the degradation temperature of the powders of plastics. In another embodiment, a master batch of the plastic powder comprising nanoscale or submicron pigment powders is prepared. These master batches can later be processed into useful products by techniques well known to those skilled in the art. In yet another embodiment, nanopigment powders are pretreated to coat the powder surface for ease in dispersability and to promote homogeneity. In a further embodiment, injection molding of the mixed powders comprising nanoscale powders and plastic powders is employed to prepare useful products.

In non-limiting embodiment for incorporating nanoscale or submicron powders into plastics consistent with teachings herein, another method for coloring plastic comprises (a) preparing nanoscale or submicron pigment powders by any method, such as a method that includes a step that operates above 1500 K and in certain embodiments above 2500 K; (b) providing a film of one or more plastics, wherein the film may be laminated, extruded, blown, cast, or molded; (c) coating the nanoscale or submicron powders on the film of plastic by techniques such as, but not limited to, spin coating, dip coating, spray coating, ion beam coating, plasma coating, sputtering. In another embodiment, a nanostructured coating is formed directly on the film by techniques such as those taught herein. In certain embodiments, the grain size of the coating is one that would qualify it as a nanoparticulate color pigment per definitions herein.

The submicron and nanoscale pigment powders taught herein may be incorporated into colored glass or colored ceramic article by any method. In one embodiment, a method for coloring glass or ceramic article comprises (a) preparing nanoscale or submicron pigment powders by any method, such as a method that includes a step that operates above 1500 K and in certain embodiments above 2500 K; (b) providing powders of one or more glasses or ceramics; (c) mixing the nanoscale or submicron powders with the powders of the glasses or ceramics; and (d) processing the mixed powders into a desired shape at temperatures less than 2000 K. In yet another embodiment, the nanopigment powders are pretreated to coat the powder surface with organic or inorganic compounds or functional groups for ease in dispersability and to ensure homogeneity. In a further embodiment, extrusion or injection molding of the mixed powders comprising nanoscale powders and glass or ceramic powders is employed to prepare useful products.

In one embodiment, a method for incorporating nanoscale or submicron powders into colored glasses or colored ceramic article comprises (a) preparing nanopigment powders by any method, such as a method that includes a step that operates above 1500 K and in certain embodiments above 2500 K; (b) providing a sheet of one or more glasses or ceramics that are laminated, extruded, cast, molded, coated, or where the sheet is a part of another product; (c) coating the nanopigment powders on the sheet of glass by techniques such as, but not limited to, spin coating, dip coating, spray coating, ion beam coating, vapor deposition, plasma coating, or sputtering. In another embodiment, a nanostructured coating is formed directly on the film by techniques such as those taught herein. In some embodiments, the grain size of the nanostructured coating is one that would qualify it as a nanoparticulate color pigment per definitions herein. While coloring glass or ceramic, fluxes and other additives may be employed as currently practiced in the art.

Nanopigments may also be similarly incorporated for the coloration/pigmentation of an inorganic binder. Such inorganic binders include, but are not limited to, hydraulic binders, aerial binders, plaster, and binders of the anhydrous or partially hydrated calcium sulfate type. Binders are substances which exhibit the property of setting and hardening after the addition of water to form water-insoluble hydrates. Nanopigments may be used to prepare colored cements and concretes produced from these cements by the addition of water, sand and/or gravel. Illustrations include, but are not limited to, cement comprising a high proportion of alumina, silica, aluminate, or silicate. Exemplary cements include, but are not limited to, the fast-setting or very fast-setting cements, white cements, sulfate-resistant cements, and those including blast ftrnace slags, fly ash, or meta-kaolin. Cements based on calcium sulfate hemihydrate and magnesia cements are also non-limiting exemplary illustrations.

Nanopigments may also be used to prepare aerial binders, that is, binders which harden in the ambient or open air by reason of the action of CO₂, of the calcium, magnesium oxide, or hydroxide type. The present invention is also applicable to the coloration of plaster and of binders of the anhydrous or partially hydrated type.

Nanopigments may similarly be incorporated into rubber formulations. For example, nanopigments may be used in products used in floor coverings, in the paper and printing inks industry, in the field of cosmetics and in a wide variety of other applications including, but not limited to, dyeing, leather finishing, and laminated coatings for kitchens and other work surfaces.

The nanopigment powders taught herein may be incorporated into paper by any method. In one embodiment, a method for coloring paper comprises (a) preparing nanopigment powders by any method, such as a method that includes a step that operates above 1500 K and in certain embodiments above 2500 K; (b) providing paper pulp; (c) mixing the nanopigment powders with the paper pulp; (d) processing the mixed powders into paper by steps such as, but not limited to, molding, couching and calendering. In yet another embodiment, the nanopigment powders are pretreated to coat the powder surface with organic or inorganic compounds or functional groups for ease in dispersability and to ensure homogeneity. In a further embodiment, nanoparticles are applied directly on the manufactured paper or paper-based product; the small size of nanoparticles enables them to impregnate and permeate through the paper fabric and thereby functionalize the paper. In the alternative, the nanoparticles may bind or adhere to the surface of the paper. In other embodiments, they may permeate and bind simultaneously.

The nanopigment powders taught herein may be incorporated into leather, fibers, or fabric by any method. In one embodiment, a method for coloring leather, fibers, or fabric comprises (a) preparing nanoscale pigment powders by any method, such as a method that includes a step that operates above 1500 K and in certain embodiments above 2500 K; (b) providing leather, fibers, or fabric; (c) impregnating and/or bonding the nanoscale pigment powders with the leather, fibers, or fabric; and (d) processing the bonded leather, fibers, or fabric into a product. In yet another embodiment, the nanopigment powders are pretreated to coat the powder surface with organic or inorganic compounds or functional groups for ease in bonding or dispersability or to ensure homogeneity. In a further embodiment, nanoparticles are applied directly on a manufactured leather, fibers, or fabric product; the small size of nanoparticles enables them to permeate through the leather, fibers (polymer, wool, cotton, flax, animal-derived, agriculture-derived), or fabric and thereby functionalize the leather, fibers, or fabric. In the alternative, the nanoparticles may bind or adhere to the surface of the leather, fibers, or fabric. In other embodiments, they may permeate and adhere simultaneously.

The submicron and nanoscale powders taught herein may be incorporated into paints, adhesives, creams, or inks by any method. In one embodiment, a method for coloring paints, adhesives, creams, or inks comprises (a) preparing nanoparticulate color pigment powders; (b) providing a formulation of paints, adhesives, creams, or inks; and (c) mixing the nanoparticulate color pigment powders with the paints, adhesives, creams, or inks. In yet another embodiment, the nanopigment powders are pretreated to coat the powder surface with organic or inorganic functional groups or compounds for ease in dispersability and to ensure homogeneity. In a further embodiment, pre-existing formulations of paints, adhesives, creams, or inks are mixed with nanoscale or submicron powders to functionalize the respective product.

### Additional Applications of Nanopigments

Nanoparticles of multimetal oxides offer some surprising and unusual benefits as color pigments. Their small size leads to more uniform dispersion in certain embodiments. For enhanced dispersability, in accordance with teachings herein, it is preferable that the nanoparticles have a small average packing number, be non-agglomerated (i.e. do not have sintered neck formation or hard agglomeration). In addition, in certain embodiments, the nanoparticles preferably should have clean surfaces or in certain embodiments a surface modified or functionalized to enable bonding with the matrix in which they need to be dispersed.

One of the process challenges for manufacturing inorganic color pigments is the ability to ensure homogeneous lattice level mixing and lattice stabilization of elements in a complex multi-metal formulation. Often mineralizers are used to ensure such homogeneous lattice level mixing at high temperatures. One of the unique features of the processes described herein is their ability to prepare complex compositions with the necessary homogeneity without the use of mineralizers and expensively complex processing strategies. Therefore, the teachings herein are suitable for creating color and making superior performing pigments with nanoparticles comprising three or more elements, two of which are metals or semimetals in certain embodiments.

Additives

Nanopigments offer unusual combinations of optical performance. These make them useful in numerous consumer applications.

Ultraviolet radiation in the 280-400 nm range causes most damage to consumer products exposed to sun light. Furthermore, ultraviolet radiation is also known to be harmfull to human skin. Superior methods for protecting consumer products and superior ultraviolet filters are commercially needed. Organic pigments and additives are currently utilized to provide such protection. However, such organic pigments typically have a limited life as they provide the protection by sacrificially absorbing ultraviolet radiation while undergoing degradation. More permanent, long lasting protection is desired. Nanoparticles of complex metal oxides with attractive colors offer a unique and surprising way to provide such long lasting superior protection. As a non-limiting example, an oxide nanoparticle comprising a cerium (Ce(IV)) ion strongly absorbs ultraviolet radiation below 400 nm while being essentially transparent to visible wavelengths of light. For UV absorption, in several embodiments, the particle size distribution is tailored such that d₉₉ of the distribution less than 100 nm, and in other embodiments less than 40 nm. Once such oxide nanoscale powders comprising Ce(IV) are available, they may be utilized to shield ultraviolet radiation and consequent damage. It should be noted that one of the unique advantages of nanoscale powder comprising rare earth elements is that by promoting purity and optimum composition, the generation of undesirable photoactivated free radicals may be prevented. Such photocatalytic radicals are commonly found with zinc oxide and titanium oxide. A specific but non-limiting example of an ultraviolet pigment would be praseodymium doped cerium oxide nanopowder with cerium content between 90% and 99% by metal basis and praseodymium content between 1% to 10% by metal basis. It is anticipated that many of the complex metal oxides taught herein will be superior ultraviolet protecting pigments as well.

Ultraviolet blocking submicron and nanoscale powders taught herein may be incorporated into plastics, wood, fabric, paints, furniture, glass, paper, food packaging materials, housing products, flooring products, car interiors, cosmetics, and other consumer products by techniques discussed herein or any other suitable method.

In one embodiment, a method for simultaneously coloring and protecting plastic products from ultraviolet radiation comprises (a) preparing nanoscale color pigment powders by any process, such as a process that includes a step that operates above 1500 K and in certain embodiments above 2500 K; (b) providing powders of one or more plastics; (c) mixing the nanoscale or submicron powders with the powders of plastics; and (d) processing the mixed powders into a desired shape. In yet another embodiment, the nanoscale or submicron powders are pretreated to coat the powder surface for ease in dispersability and to ensure homogeneity. In a further embodiment, extrusion or injection molding of the mixed powders comprising nanoscale powders and plastic powders may be employed to prepare useful products.

These plastics may be either thermoplastic or thermosetting plastics. Thermoplastic resins well suited for coloration/pigmentation include, but are not limited to, polyvinyl chloride; polyvinyl alcohol; polystyrene; styrene/butadiene; styrene/acrylonitrile; acrylic polymers; acrylonitrile/butadiene/styrene(ABS) copolymers; polymethylmethacrylate; polyolefins such as polyethylene, polypropylene, polybutene, and polymethyl pentene; cellulose derivatives such as cellulose acetate, cellulose acetobutyrate, and ethyl cellulose; and polyamides. Thermosetting resins well suited for coloration/pigmentation include, but are not limited to, phenolic plastics; aminoplastics, especially urea/formaldehyde and melamine/formaldehyde copolymers; epoxy resins; and heat-curable polyesters.

The compounds/compositions of the present invention are also useful for the coloration of special polymers, such as fluoropolymers (in particular polytetrafluoroethylene (PTFE)), polycarbonates, silicone elastomers, polyimides, saturated polyesters (such as PET and PBT), and polyacetals.

For this specific application of coloration of plastics, the compounds/compositions of the present invention may be used directly in powder form. In certain embodiments, they may also be used in a predispersed form, for example as a premix with a proportion of the resin, or in the form of a paste concentrate, or of a liquid, which permits the same to be introduced at any stage in the production of the resin.

The application of the present pigments in plastics is typically carried out in two steps—by first mixing the nanopigment in a high concentration with a medium or plastic, which is in certain embodiments miscible with the plastics to be finally colored. Such a colored concentrate is commonly referred to as color concentrate or master batch. These master batches typically comprise more than 10% by weight of pigment and these are then usually processed in amounts ranging from 0.025% to approximately 7.5 weight % in the final plastics. As a result, a typical concentration of 0.005% to approximately 3 weight % pigment is obtained in the final product.

The manufacture of a master batch may be carried out by mixing the pigments with the plastics in the melt using conventional mixing apparatus, such as rollers and kneaders and compounder extruders, yielding a homogeneous granulate. While mixing the pigments to form a color concentrate, additives may be added that facilitate the dispersion of the pigment in the high-viscosity plastics and promote the stability and the processability of the final product. Such additives may consist of commercially available internal and external lubricants, thermal stabilizers, UV stabilizers, surface-active substances, dispersing aids, coupling agents, etc. However, it is also possible to add some or all of these additives during the subsequent manufacture of the final colored plastics product.

The master batch thus obtained, for instance in the form of a granulate, may then be added in the desired amount to the plastics to be colored and homogeneously mixed with the plastics. In some embodiments, the mixing is performed at an elevated temperature and in other embodiments at low to cryogenic temperatures. The warm mixture may then be molded, extruded, or blown into the desired shape, so that plastics articles of a good, uniform, and stable color may be obtained.

The techniques for processing pigments in plastics may be extended to other products, such as natural and synthetic rubber and various other natural and synthetic products comprising carbon. Accordingly, the above description is only intended as an elucidation of these generally known techniques.

Another important nanopigment application relates to the manufacture of glass, in particular of packaging glass. For that purpose, nanopigment may be added, typically in amounts ranging from 0.1% to 10% by weight to a standard glass composition. From this, a glass melt may be formed at a conventional temperature, for instance about 1700 K so, as to incorporate the nanopigment homogeneously without causing cloudiness, bubble formation, or deglazing. The glass melt may be used to manufacture articles such as bottles, containers, and packaging article. When a yellow praseodymium zirconium silicate nanopigment of the present invention is thus incorporated into articles, such as food packaging, lotion containers, or beer bottles, the packaging is colored while protecting the product packaged therein against the detrimental action of light.

In other embodiments, glasses may be used in the place of or in combination with plastics in methods for simultaneously coloring and protecting goods from ultraviolet radiation. In a similar way, beautiful color and ultraviolet protective capability may be simultaneously added to composites, wood, adhesives, fabrics, paints, inks, furniture, leather, paper, food packaging materials, housing products, flooring products, car interiors, biomedical storage products, blood storage containers, bio-fluid containers, road signs, and indicators.

In yet other embodiments, cosmetics may be enhanced to provide protection from ultraviolet radiation using method comprising (a) preparing nanoscale oxide color pigment powders by any method, such as the methods taught herein; (b) providing a medium, such as a cream, base, wax, spray, or solution; (c) dispersing the nanoscale oxide color pigment powders into the medium; and (d) applying the medium over the surface that needs protection. In some embodiments, this method may be used with existing cosmetics or personal care products. A few key and surprising advantages that may be obtained using the approaches taught herein for protecting skin are (a) the ability to maintain color transparency while eliminating over 90%, and in certain embodiments, 99% or more of the ultraviolet radiation reaching the skin, (b) the ability to produce ecologically and environmental benign products, (c) the ability to produce effective concentrations as low as 10% by weight, in certain embodiments less than 5%, and in certain embodiments less than 2.5% by weight, (d) the absence of a high fraction of photocatalytically created radicals, (e) broad spectrum permanent protection from harmful ultraviolet radiations, (f) ease of dispersion in various media up to 10 weight % or higher, and (g) compatibility and stability of the nanoparticles with other additives (such as vitamins) added to skin protective formulations. On account of nanopigments' small sizes and their possible benefit to health, the present pigments are suitable to be processed in appropriate concentrations in cosmetic products, such as skin lotions, creams, lipstick, eye shadow, and nail polish.

The teachings above may also be useful in coloring packaging materials that simultaneously protect vegetables, fruits, meats, and packaged food. It is well known that foods that contain fats or oils (potato chips, snacks, meat, soups, etc.) degrade when exposed to light, in particular when exposed to ultraviolet radiation. In one embodiment, a method for enhancing the storage life of food and of protecting food in a colored transparent packaging comprises (a) preparing nanoscale color pigment powders; (b) providing powders or films of one or more plastics; (c) mixing or coating the nanoscale or submicron powders onto the plastic film (laminates) or with the powders of plastics; and (d) processing the film or mixed powders into a desired package or shape. Current techniques for protecting fat containing food are to package them in metal, paper, cans, or in laminated plastic bags that include a metal layer such as aluminum. These current techniques often prevent the consumer from viewing the quality of the product and thereby limit the ability for marketing premium products. A key and surprising advantage of the approach taught herein for protecting food is the ability to maintain visual transparency of the packaging material while eliminating over 95%, in certain embodiments 99% or more of the ultraviolet radiation reaching the product. The color may be used for branding, marketing purposes, or for functional purposes.

The teachings herein may be used to color and enhance the life of and protect paper, archival materials, prints, photographs, currency, valuable documents such as passports, art work, fabric, and other products. These products degrade when exposed to light, in particular when exposed to ultraviolet radiation. In one embodiment, a method for enhancing the useful life of paper, archival materials, prints, photos, currency, valuable documents such as passports, fabric, art work, and other products, comprises (a) preparing color nanopigment powders; (b) providing paper, archival materials, prints, photos, currency, valuable documents such as passports, fabric, art work, and other products; and (c) infiltrating or coating the nanopigment powders onto the paper, archival materials, prints, photos, currency, valuable documents such as passports, fabric, art work, and other products thereby reducing the UV radiation caused damage to the paper, archival materials, prints, photos, currency, valuable documents such as passports, fabric, art work, and other products. Key and surprising advantages possible using the approaches taught herein for protecting paper, archival materials, prints, photos, currency, valuable documents such as passports, fabric, art work, and other products are (a) the ability of nanoparticles to infiltrate or nanolayer coat the pores or ink of the product and adhere to the fibers constituting the product, (b) the ability to maintain transparency and appeal of the product while eliminating over 95%, and in certain embodiments 99% or more of the ultraviolet radiation reaching the product. In another embodiment, this technique is used to color and protect consumer articles through incorporating the nanoparticles in preservative polishes, protective sprays, and other such protective varnishes and creams. One advantage of nanopigment-based UV absorbing powders is that they may be engineered to be environmentally benign when the product is disposed of or destroyed by techniques such as incineration. Similarly, while UV pigments are discussed above, with composition optimization, color nanoparticles may be made to reflect or absorb infrared (IR) wavelengths. Such IR pigments may be used with glass, plastics, other products to improve thermal management of the environment inside a package, inside a room, inside a passenger cabin, or inside a instrument/engine containing cover/hood (electrical boxes, optical boxes, cable boxes, signage systems, transformer coverings, cars, airplanes).

In another embodiment, this technique is used to protect biomedical products, device components and pharma products sensitive to ultraviolet radiation; for example, this technique may be used to protect medicines, bioactive liquid droplets, tracers, markers, biomedical reagents, blood, biological samples, device tubing, catheters, angioplasty kits, components, etc. In a further embodiment, glass is used instead of plastics as the packaging materials above in combination with nanoscale and submicron powders to provide protection from UV radiation and/or to filter out bright colors that distort vision.

Multifunctional Additives

Nanoscale and submicron pigment powders offer some unusual opportunities as additives to provide color while simultaneously enhancing non-optical performance of the product incorporating the nanopigment. Some non-limiting illustrations of such multifunctional performance that may be offered by nanoscale and submicron pigment powders are (a) beautiful color and enhanced modulus, hardness and toughness of polymers or other matrix, (b) color and magnetic properties, (c) color and electrochemical properties (e.g. corrosion resistance), (d) color and luminescence, (e) color and luster, (f) color and thermal insulation, (g) color and fire resistance, (h) color and transparency, and (i) color and anti-microbial activity.

For example, in one embodiment, praseodymium zirconium silicon oxide yellow nanopigment powders (or vanadium zirconium silicon oxide blue nanopigment powders or iron titanium oxide brown nanopigment powders) are mixed with resins, adhesives, plastics, or alloys of plastics in an amount at least 10% by weight, and in certain embodiments greater than 25% by weight, to provide color and simultaneously enhance the hardness of the matrix by over 100%. In other embodiments, ceramics, metals, or alloys may be employed. A non-limiting illustration of a method of adding color and enhancing the structural property of a ceramic, metal, alloy, or polymeric part comprises (a) preparing nanoscale color pigment powders; and (b) mixing or coating the nanoscale color pigment powders to the article of ceramic, metal, alloy, or polymer.

A few non-limiting examples of multifunctional nanopigments that simultaneously provide color and magnetic performance comprise cobalt, chromium, nickel, iron, rare earth element, or combinations thereof. For example, cobalt iron oxide, cobalt silicon oxide, or nickel silicon oxide nanopigment powders are mixed with a resin, adhesive, plastic, or an alloy of plastics in an amount at least 1% by weight, and in certain embodiments greater than 25% by weight, to provide color and simultaneously enhance the magnetic properties of the matrix. In other embodiments, a ceramic, metal, alloy, paper, or fabric may be employed. A non-limiting embodiment of a method of adding color and enhancing the magnetic property of a ceramic, adhesive, paper, fiber, ink, or polymeric part comprises: (a) preparing nanoscale color pigment powders comprising cobalt, chromium, nickel, iron, or rare earth element; and (b) mixing, coating, printing, or painting the nanoscale color pigment powders to the article of ceramic, adhesive, paper, fiber, ink, or polymeric part. Such colored magnetic nanopigments may be used to create superior security inks, markers, toys, marketing materials, currency and security documents, barcodes, inventory tracking technologies, theft prevention tools, quality assurance, safety products appealing to customers.

few non-limiting example of multifunctional nanopigments that simultaneously provide color and anticorrosive (electrochemical) functional performance comprise zinc, chromium, lead, boron, silicon, rare earth elements, or combinations thereof. Phosphorus comprising nanopigments are anticipated to be superior pigments in certain situations. Furthermore, flake type nanopigments are expected to perform better in such role. For example, chromium calcium silicate green nanopigment coated on silane-treated mica flakes, silane-treated talc, or silicates or nanoclay flakes (such as those available from JM Huber®, Rockwood® Specialities Inc. and Nanocor®) may be mixed with a resin and may then be applied to a metal or an alloy object to provide color and simultaneously enhance the corrosion resistance properties of the object. Lamellar nanopigments typically pack in layers thereby (a) obstructing the pathway of corrosion causing ions, (b) lengthening the pathways for diffusion of ions, and (c) providing color. Nanopigment oxides or hydrates may function through other mechanisms to provide corrosion resistance such as (a) maintaining the pH of the environment around the metal or alloy surface, (b) provide suitable oxidation potential so as to provide anodic or cathodic protection. Some non-limiting examples of such nanopigment compositions are zinc chromium oxide yellow nanopigment, lead chromium silicon oxide orange nanopigment, zinc potassium chromium oxide yellow nanopigment, zinc iron oxide brown nanopigment, calcium lead oxide beige nanopigment, strontium chromium oxide yellow nanopigment, and sodium zinc molybdenum oxide nanopigment. Such colored electrochemically protected surfaces are anticipated to be useful in demanding environments (e.g., high temperature, acidic, alkaline, sea water, articles subject to exposure to rain, snow, salt, wash water, and cooking utensils).

A few non-limiting example of multifunctional nanopigments that simultaneously provide color and luminescence performance comprise zinc, copper, vanadium, tantalum, niobium, alkali earth elements, aluminum, silicon, gallium, manganese, germanium, cadmium, rare earth elements, or combinations thereof. While oxides are useful in certain embodiments herein, nanopigments comprise sulfur, selenium, nitrogen, phosphorus or halogens in place of or in addition to oxygen in certain embodiments. In one embodiment, europium yttrium oxide (Eu³⁺ between 0.1 to 10% by mol), rare earth doped alkaline earth silicates, or rare earth doped alkaline earth aluminates nanopigment powders are processed with a resin, adhesive, plastic, alloy of plastics, or glass in an amount at least 1% by weight, and in certain embodiments greater than 25% by weight, to provide color and simultaneously enhance the luminescent properties of the matrix. In other embodiments a ceramic, metal surface, wood, paper, or fabric may be employed. In one embodiment, a method of adding color and enhancing the luminescent property of a glass, ceramic, adhesive, paper, fiber, ink, metallic surface, or polymeric article comprises (a) preparing nanoscale color pigment powders comprising zinc, copper, alkali earth elements, vanadium, tantalum, niobium, aluminum, silicon, gallium, manganese, germanium, cadmium, rare earth element, or combination thereof; and (b) mixing, coating, printing, or painting the nanoscale color pigment powders to the article. Multiple layers of the same or different nanopigments may be employed. Different nanopigments may be mixed for specific applications. Nanopigments with luminescence properties may be used in different applications. For example, the following types of luminescence and known applications thereof may be performed or assisted with the use of nanopigments: photoluminescence, cathodoluminescence, X-ray luminescence, ionluminescence, triboluminescence, electroluminescence, bioluminescence, and chemiluminescence. Colored luminescent nanopigments may be used to create superior roadway signs, airport and public places signs, worker clothing, safe evacuation under power failure signs, lighting products, plastic covering for electrical switches, keys for opening locks, stairs, long glowing advertisements, cosmetics, dental pastes, radiation detectors, security inks, markers, toys, marketing materials, product piracy prevention codes, currency and security documents, theft prevention tools, display screens, and safety products appealing to consumers.

Similarly, nanopigment additives may simultaneously offer color and enhanced thermal properties (lower or higher thermal conductivity), or color and luster through the use of multilayered pigments and/or coatings, or color and fire resistant properties through the use of hydrates or antimony containing compounds or other formulations.

Multifunctional nanopigments that simultaneously provide color and anti-microbial performance, in certain embodiments, comprise zinc, copper, silver, titanium, silicon, or combinations thereof. While oxides are used in certain embodiments herein, in other embodiments nanopigments comprise pure atomically ordered forms of metal; in other embodiments sulfur, nitrogen, phosphorus or halogens are used in addition to or in place of oxygen. In one embodiment, silver coated titanium oxide (Ag metal concentration ranging from 1% to 90% by volume) may be processed with a resin, adhesive, plastic, an alloy of plastics, or glass in an amount at least 1% by weight, and in certain embodiments greater than 25% by weight, to provide color and simultaneously enhance the anti-microbial properties of the matrix. In other embodiments, a ceramic, metal surface, wood, paper, or fabric may be employed. In one embodiment, a method of adding color and enhancing the anti-microbial properties of a glass, ceramic, adhesive, paper, fiber, ink, metallic surface, or polymeric article comprises (a) preparing nanoscale color pigment powders comprising zinc, copper, silver, titanium, silicon, zirconium, or combinations thereof; and (b) mixing, coating, printing, or painting the nanoscale color pigment powders to the article. Multiple layers of the same or different nanopigments may be employed. Different nanopigments may be mixed for specific applications.

Processing Advantages

The described characteristics of nanopigments are of importance for uses in the ceramics industry, but most certainly outside that field as well, and in particular in plastics, rubber, paint, printing ink, and cosmetics. Good color strength and high thermal stability are important for ceramic applications. The nanopigments are particularly suited to serve the needs of ceramic techniques involving only short to very short calcination times. In one embodiment, nanopigments in the desired concentration, which is typically in the range from 1% to 15% by weight basis (but is higher or lower in other embodiments), are added to and homogeneously mixed with a conventional glaze for manufacturing bright, cloudy, or opaque glaze layers. Such glazes are generally known and commercially available. They are typically composed of a mixture of silicates in an aqueous medium. The nanopigment mixture thus formed are applied, for example by brushing, to a suitable substrate, for instance a clay tile, in a thin layer, whereafter the article is fired in an oven.

In certain embodiments, nanoparticulates coated with a layer of transparent oxide are employed for the coloration of ceramic materials, such as, porcelain, crockery and stoneware, either by coloration of the ceramic throughout its volume (physical mixing of the ceramic powder with the pigment) or by coloration of only the face surface of the latter by means of glazes (coating glazing compositions) containing the nanopigment.

For applications in fields other than ceramics, good color strength and high particle fineness are of typically of particular importance, as well as the minor abrasive action, which prevents wear of the processing installations.

In some applications, nanopigment or a suitable concentrate comprising nanopigment are homogeneously mixed with a vehicle. After mixing, it may be applied depending on the application contemplated. Applications suitable include, but are not limited to, the use in paint and printing ink (both water-based and organic solvent-based) where the final pigment concentration is higher or even considerably higher than in the earlier described plastics and rubber applications. In paint and printing ink, the pigment concentration is typically ranges from 1% to 50%, depending on the type of paint or printing ink.

Paints and varnishes may be prepared from nanopigments in the following resins: alkyd resins, the most typical of which being glycerophthalic, resins modified with tall or short oil, acrylic resins prepared from esters (methyl or ethyl) of acrylic and methacrylic acid, optionally copolymerized with ethyl, 2-ethylhexyl or butyl acrylate, vinyl resins such as, polyvinyl acetate, polyvinylformal, polyvinyl chloride, polyvinylbutyral, vinyl chloride and vinyl acetate or vinylidene chloride copolymers, aminoplastic or phenolic resins which are typically modified, polyester resins, polyurethane resins, epoxy resins and silicone resins. In typical applications, it is recommended that nanopigments be generally formulated in a proportion of 1% to 40% by weight of the paint and from 0.01% to 7.5% by weight of the varnish.

Nanopigments may be particularly useful in automotive coatings, industrial coatings, powder coatings, wood coatings, construction, corrosion protection, adhesives, footwear, packaging products, furniture, textile coatings, and other specialties.

The following examples illustrate the invention as described herein. However, the examples only demonstrate certain embodiments and are not to be considered as limiting the invention. Unless otherwise indicated, surface areas reported are measured with 5 point BET method, crystallite sizes are measured using Warren-Averbach method on spectra obtained from a X-ray diffractometer, and other terms are those described elsewhere herein and those that are known in the art.

### EXAMPLE 1

### Yellow Pigment Powders

99.9 weight % by metal pure cerium ethylhexanoate precursor was diluted with hexane until the viscosity of the precursor was less than 100 cP. This mix was sprayed into a thermal plasma reactor at a rate of about 75 ml/min using about 240 standard liters per minute oxygen. The peak temperature in the thermal plasma reactor was above 2000 K. The vapor was cooled and then quenched by Joule-Thompson expansion. The powders collected were analyzed using X-ray diffraction (Warren-Averbach analysis) and BET. It was discovered that the powders had an average crystallite size of less than 75 nm and a specific surface area greater than 25 m²/gm. The color of the powder was light yellow. A high resolution transmission electron microscopy study suggested that the average packing number of the nanopigments was less than 100. This example shows that rare earth elements can create color nanopigments.

### EXAMPLE 2

### Buff and Red Pigment Powders

Praseodymium-doped cerium precursor was processed in the same manner as in Example 1. It was discovered that the powders had a crystallite size of less than 100 nm and a specific surface area greater than 10 m²/gm. The color of the powder was buff to red depending on the concentration of praseodymium in the precursor. This example shows that doping by rare earths can create color pigments and that the thermal plasma process can be used to create reddish color nanopigments.

### EXAMPLE 3

### Blue Pigment Powders

A mixture comprising ammonium metatungsate and tin organometallic compound were processed in a thermal quench reactor with peak temperature above 2000 K. The vapor was cooled and then quenched by Joule-Thompson expansion. It was discovered that the powders had an average crystallite size of less than 40 nm. The color of the powder was observed to be a beautiful blue. This example shows that the thermal plasma process can be used to create blue color nanopigments.

The blue powder was dispersed in water by sonication and the resulting ink was painted onto a paper using a commercially available painter's brush. Once the ink dried, the blue color remained attached to the paper.

### EXAMPLE 4

### Yellow Pigment Powders

A mixture comprising bismuth octoate and naphtha were processed in a thermal quench reactor with peak temperature above 2000 K. The vapor was cooled and then quenched by Joule-Thompson expansion. It was discovered that the powders had an average crystallite size of less than 40 nm. The color of the powder was observed to be yellow. This example shows that the thermal plasma process can be used to create yellow color nanopigments.

### EXAMPLE 5

### Green Pigment Powders

A organometallic mixture comprising nickel, calcium and aluminum compounds was processed in a thermal quench reactor with peak temperature above 2000 K. The vapor was cooled and then quenched by Joule-Thompson expansion. It was discovered that the powders had an average crystallite size of less than 10 nm and a specific surface area greater than 70 m²/gm. The color of the powder was observed to be greenish. This example shows that the thermal plasma process can be used to create green color nanopigments. The example also shows that multimetal compositions of nanopigments can be successfully prepared.

### EXAMPLE 6

### Multifunctional Pigment Powders

An organometallic mixture comprising nickel, zinc, manganese, copper and iron compounds was processed in a thermal quench reactor with peak temperature above 2000 K. The vapor was cooled and then quenched by Joule-Thompson expansion. It was discovered that the powders had an average particle size less than 200 nm and a specific surface area greater than 5 m²/gm. The color of the powder was observed to be brownish. The powder was also found to be magnetic. This example shows that the thermal plasma process can be used to create brownish color nanopigments. This example also shows that the thermal plasma process can be used to create multifunctional color nanopigments derived from complex five metal oxides.

### EXAMPLE 7

### Multifunctional Pigment Powders

An organometallic mixture comprising zinc, copper and iron compounds was processed in a thermal quench reactor with peak temperature above 2000 K. The vapor was cooled and then quenched by Joule-Thompson expansion. It was discovered that the copper zinc ferrite powders had an average particle size less than 20 nm and a specific surface area greater than 25 m²/gm. The color of the powder was observed to be brownish. The powder was found to exhibit magnetic properties. This example shows that the thermal plasma process can be used to create brown color nanopigments. This example also shows that the thermal plasma process can be used to create color nanopigments derived from complex three metal oxides.

### EXAMPLE 8

### Black Pigment Powders

An octoate mixture comprising manganese and iron compounds was processed in a thermal quench reactor with peak temperature above 2000 K. The vapor was cooled and then quenched by Joule-Thompson expansion. It was discovered that the manganese ferrite powders had an average particle size less than 50 nm and a specific surface area greater than 30 m²/gm. The color of the powder was observed to be black.

### EXAMPLE 9

### Grey Pigment Powders

Cerium boride was processed in a thermal quench reactor with peak temperature above 2000 K. The vapor was cooled and then quenched by Joule-Thompson expansion. It was discovered that the powders had an average particle size less than 100 nm and a specific surface area greater than 10 m²/gm. The color of the powder was observed to be grey. This example shows that the thermal plasma process can be used to create grey color nanopigments. This example also shows that the thermal plasma process can be used to create color nanopigments derived from non-oxides.

### EXAMPLE 10

### Dark Blue Pigment Powders

Cobalt octoate was mixed with aluminum octoate such that the elemental ratio of Co to Al was 1:2.25. 30 liters of this mixture were processed at the rate of 10 liters per hour in a thermal quench reactor as taught herein with peak a temperature above 3000 K. The vapor was cooled and then quenched by Joule-Thompson expansion. Over 2500 grams of powders were collected. It was discovered that the powders had an average particle size less than 50 nm and a specific surface area greater than 30m²/gm. The color of the powder was observed to be strong blue. 100 grams of the powder were heated in air and another 100 grams were heated under argon at 900° C. for 1 hour. The heat treated powders remained nanoscale, transparent, and became a brilliant and beautiful blue. The powder heat treated under argon had a higher color strength than the one heated under air (both were stronger than the PB28 blue commercially available). This example shows that the thermal plasma process can be used to create blue color nanopigments. This example also shows that the post treatment of color powders can be used to develop and enhance or modify the attributes and performance of color nanopigments.

### EXAMPLE 11

### Light Blue Nanopigments

Neodymium carbonate was dissolved in 2-ethyl hexanoic acid which was then used to prepare nanoparticles of neodymium oxide using the process described herein. The powder was found to be light blue and have a BET surface area greater than 30 m²/gm, an equivalent particle size less than 40 nanometers. This example illustrates that teachings herein can be used to prepare color nanopigments from rare earth elements.

### EXAMPLE 12

### Rare Earth Oxide Nanopigments

99.9%+Terbium nitrate hydrate was dissolved in isopropyl alcohol which was then used to prepare nanoparticles of terbium oxide using the process described herein in example 1. The powder was found to be brown and have a surface area greater than 10 m²/gm and an equivalent particle size less than 80 nanometers. This example illustrates that teachings herein can be used to prepare color nanopigments from rare earth elements.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method for coloring a composition of matter comprising:
preparing a color nanopigment,
wherein the color nanopigment exhibits at least 10% more transparency than coarse color pigment of substantially same composition with at least 1 micrometer mean particle size;
wherein the transparency is measured at a wavelength between 300 nanometers and 800 nanometers; and
combining the color nanopigment and the composition of matter.

2. The method of claim 1, wherein the composition of matter comprises plastic.

3. The method of claim 1, wherein the composition of matter comprises ceramic.

4. The method of claim 1, wherein the composition of matter comprises cement.

5. The method of claim 1, wherein the composition of matter comprises glass.

6. The method of claim 1, wherein the composition of matter comprises wood.

7. The method of claim 1, wherein the composition of matter comprises fibers.

8. The method of claim 1, wherein the composition of matter comprises paint.

9. The method of claim 1, wherein the composition of matter comprises ink.

10. The method of claim 1, wherein the color nanopigment comprises at least one oxide.

11. The method of claim 1, wherein the color nanopigment comprises at least one nitride.

12. The method of claim 1, wherein the color nanopigment comprises at least one element with atomic number greater than 21.

13. The method of claim 1, wherein the color nanopigment comprises at least one organic compound.

14. The method of claim 1, further comprising heating the color nanopigment before combining the color nanopigment and the composition of matter.

15. The method of claim 1, wherein the combining comprises coating the composition of matter.

16. The method of claim 1, wherein the combining comprises bonding the color nanopigment and composition of matter.

17. The method of claim 1, wherein the combining comprises impregnating the composition of matter with the color nanopigment.

18. The method of claim 1, wherein the combining comprises mixing the color nanopigment and composition of matter.

19. The method of claim 1, wherein the color nanopigment has an average packing number less than 1000.

20. The method of claim 1, wherein the color nanopigment comprises at least one inorganic compound.
